(19) United States
(12) Patent Application Publication
(10) Pub. No.: US 2010/0274663 A1
(43) Pub. Date: Oct. 28, 2010

(54) RESOURCE OPTIMIZATION

(76) Inventors: Mark Hinton, Rickmansworth (GB); Carlo Platia, Pyrford (GB)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/429,096

(22) Filed: Apr. 23, 2009

(51) Int. Cl. G06F 15/173; G06Q 30/00; G06Q 10/00; G06F 9/45; G06F 3/01

(52) U.S. Cl. 705/14.43; 705/14.45; 709/226; 717/151; 715/738

(57) ABSTRACT

A network, method and program for allocating viewable screen area resources amongst a plurality of competing portions of content in a network comprising a plurality of end-user terminals and one or more servers operatively coupled to the end-user terminals over the network, each of those servers storing data representing one or more respective viewable screen areas and being arranged to make the viewable screen areas accessible to the end-user terminals over the network, there thus being finite viewable screen area resources accessible to the end-user terminals from those servers. The method involves performing a simulation of the network to generate proposals for changes to the resource allocation. The method may also involve forecasting effects of proposed changes. The simulation may be by means of multi-agent modeling.

### FIELD OF THE INVENTION

The present invention relates to optimizing the allocation of finite system resources in a network.

### BACKGROUND OF THE INVENTION

In a network there are a number of different system resources to be considered, relating to the various different physical operations of the nodes making up the network. The total resources available may vary with time, but at any given time there are only finite resources available, which may not be sufficient to satisfy the ideal requirements of all parties making use of the network. Therefore a decision needs to be made as to how best to allocate the resources amongst the needs of the different parties, so as to try to maximize the overall benefit of the available resources.

In some situations it may be desirable to automate the making of decisions, i.e. to remove the decision-making processes from human beings and replace them by automated engines. However, a number of difficulties arise with automated decision-making processes, which are particularly pertinent when there is a need to make and implement decisions in real time. One particular difficulty is the uncertainty about consequences of certain decisions, which can only be felt after they have been implemented. Another difficulty is where there are a number of parties with factors to feed into a decision making process and who will be affected by the results of a decision making process in different ways.

### SUMMARY OF THE INVENTION

The present invention provides automated decision-making for the allocation of finite viewable screen area resources in a network.

According to one aspect of the present invention, there is provided a network comprising: a plurality of end-user terminals; one or more servers operatively coupled to the end-user terminals over said network, each storing data representing one or more respective viewable screen areas and being arranged to make the viewable screen areas accessible to the end-user terminals over said network, there thus being finite viewable screen area resources accessible to the end-user terminals from those servers; a data store; and installed at one or more servers of said network, optimization code arranged to allocate said viewable screen area resources amongst a plurality of competing portions of content, wherein the optimization code is operatively coupled to the data store and configured to: perform a simulation of the network in order to generate proposals for changes to said resource allocation, record in the data store a history of effects of the resource allocation, and forecast an effect of proposed changes to the resource allocation based on the recorded history; such that changes to the resource allocation can be based on analysis of the forecast in relation to target parameters for the content.

In embodiments, the optimization code may comprise a first plurality of autonomous code modules for use in said simulation, each of the first modules representing respective content competing for said finite viewable screen area resources, and each of the first modules comprising: data representing a set of target parameters relating to its respective content, a first code portion configured to determine potential changes to the resource allocation based on its respective target parameters and signal the potential changes to others of said modules, and a second code portion configured to determine whether such potential changes signaled from others of said first modules are acceptable according to its own respective target parameters; wherein the optimization code may be configured to generate said proposed changes from said potential changes in dependence on whether thus determined acceptable.

The optimization code may comprise a second plurality of autonomous code modules for use in said simulation, each of the second modules representing a respective screen area resource, each of the second modules comprising: data representing a set of characterizing parameters of the respective resource, and a code portion configured to determine matches between the characterizing parameters of the resource and target parameters of the content represented by the first optimization modules; wherein the optimization code may be configured to generate said proposed changes based on said matches.

The optimization code may be configured to output the forecast to an operator, allowing the operator to manually determine whether to accept the proposed changes.

The optimization code may be configured to provide said forecast to one or more of the second modules for use as one or more of the respective characterizing parameters.

The optimization code may be configured to forecast at least one of: a number of user interactions with the content, a number of user viewings of the content, and a ratio of user interactions to viewings.

Said target parameters of the first modules may comprise at least one of: a number of user interactions with the content, a number of user viewings of the content, and a ratio of user interactions to viewings.

Said characterizing parameters of the second modules may comprise at least one of: a number of user interactions with the content, a number of user viewings of the content, and a ratio of user interactions to viewings.

The optimization code may be configured to generate new suggestions when the quantity of viewable screen area resources available changes.

The optimization code may be configured to generate new suggestions when the quantity of content to which the viewable screen area resources are to be allocated changes.

The optimization code may be configured to perform said forecast for at least a week into the future.

Said content may comprise advertising content.

According to another aspect of the present invention, there is provided a method of allocating viewable screen area resources amongst a plurality of competing portions of content in a network comprising a plurality of end-user terminals and one or more servers operatively coupled to the end-user terminals over said network, each of those servers storing data representing one or more respective viewable screen areas and being arranged to make the viewable screen areas accessible to the end-user terminals over said network, there thus being finite viewable screen area resources accessible to the end-user terminals from those servers, the method comprising: performing a simulation of the network in order to generate proposals for changes to said resource allocation, recording in a data store a history of effects of the resource allocation, forecasting an effect of proposed changes to the resource allocation based on the recorded history, and changing the resource allocation in dependence on analysis of the forecast in relation to target parameters for the content.

The method may further comprise steps in accordance with any of the above network features.

According to another aspect of the present invention, there is provided a computer program product for allocating viewable screen area resources amongst a plurality of competing portions of content in a network comprising a plurality of end-user terminals and one or more servers operatively coupled to the end-user terminals over said network, each of those servers storing data representing one or more respective viewable screen areas and being arranged to make the viewable screen areas accessible to the end-user terminals over said network, there thus being finite viewable screen area resources accessible to the end-user terminals from those servers, the program comprising code embodied on a computer readable medium and configured so as when executed to perform the steps of: performing a simulation of the network in order to generate proposals for changes to said resource allocation, recording in a data store a history of effects of the resource allocation, forecasting an effect of proposed changes to the resource allocation based on the recorded history, and enabling the resource allocation to be changed in dependence on analysis of the forecast in relation to target parameters for the content.

The program code may be further configured in accordance with any of the above network features.

According to another aspect of the present invention, there is provided a network comprising: a plurality of end-user terminals; one or more servers operatively coupled to the end-user terminals over said network, each storing data representing one or more respective viewable screen areas and being arranged to make the viewable screen areas accessible to the end-user terminals over said network, there thus being finite viewable screen area resources accessible to the end-user terminals from those servers; a data store; and installed at one or more servers of said network, optimization code comprising a plurality of autonomous code modules, each of the modules representing respective content competing for said finite viewable screen area resources, and each of the first modules comprising: data representing a set of target parameters relating to its respective content, a first code portion configured to determine potential changes to the resource allocation based on its respective target parameters and signal the potential changes to others of said modules, and a second code portion configured to determine whether such potential changes signaled from other of said first modules are acceptable according to its own respective target parameters; such that changes to the resource allocation can be based on said potential changes if thus determined acceptable.

This network may be further configured in accordance with any of the above features.

According to another aspect of the present invention, there is provided a computer program product for allocating viewable screen area resources amongst a plurality of competing portions of content in a network comprising a plurality of end-user terminals and one or more servers operatively coupled to the end-user terminals over said network, each of those servers storing data representing one or more respective viewable screen areas and being arranged to make the viewable screen areas accessible to the end-user terminals over said network, there thus being finite viewable screen area resources accessible to the end-user terminals from those servers, the program comprising code embodied on a computer readable medium and configured so as when executed to perform the steps of: performing a simulation of the network in order to generate proposals for changes to said resource allocation, wherein said simulation is performed by execution of a first plurality of autonomous code modules, each of the first modules representing respective content competing for said finite viewable screen area resources, and each of the first modules comprising data representing a set of target parameters relating to its respective content, the execution of each of the first modules comprising determining potential changes to the resource allocation based on its respective target parameters and signaling the potential changes to others of said modules, and determining whether such potential changes signaled from others of said first modules are acceptable according to its own respective target parameters; and enabling the resource allocation to be changed based on said potential changes if thus determined acceptable.

This method may further comprise steps in accordance with any of the above network features.

According to another aspect of the present invention, there is provided a method of allocating viewable screen area resources amongst a plurality of competing portions of content in a network comprising a plurality of end-user terminals and one or more servers operatively coupled to the end-user terminals over said network, each of those servers storing data representing one or more respective viewable screen areas and being arranged to make the viewable screen areas accessible to the end-user terminals over said network, there thus being finite viewable screen area resources accessible to the end-user terminals from those servers, the method comprising: performing a simulation of the network in order to generate proposals for changes to said resource allocation, wherein said simulation is performed by execution of a first plurality of autonomous code modules, each of the first modules representing respective content competing for said finite viewable screen area resources, and each of the first modules comprising data representing a set of target parameters relating to its respective content, the execution of each of the first modules comprising determining potential changes to the resource allocation based on its respective target parameters and signaling the potential changes to others of said modules, and determining whether such potential changes signaled from others of said first modules are acceptable according to its own respective target parameters; and changing the resource allocation based on said potential changes if thus determined acceptable.

This program code may be further configured in accordance with any of the above network features.

### BRIEF DESCRIPTION OF THE DRAWINGS

For a better understanding of the present invention and to show how it may be carried into effect, reference will now be made by way of example to the accompanying drawings in which:

FIG. 1a is schematic illustration of resource usage in a network,

FIG. 1b is a schematic illustration of a multi-agent simulation,

FIG. 1c is a schematic block diagram of a resource optimizing system,

FIG. 2 is a schematic illustration of an example of resource allocation,

FIG. 3 is a schematic illustration of a reallocation of the resources of FIG. 2,

FIG. 4 shows schematically a further reallocation of the resources of FIG. 2,

FIG. 5 is a schematic representation of a part of a user interface, and

FIG. 6 is a schematic illustration of another part of a user interface.

### DETAILED DESCRIPTION OF THE INVENTION

A description of example embodiments of the invention follows.

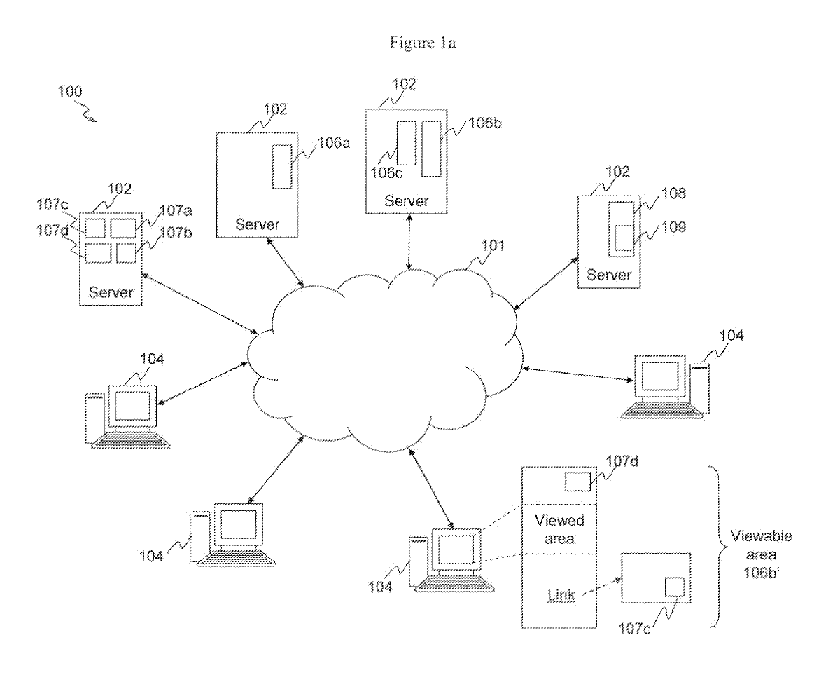

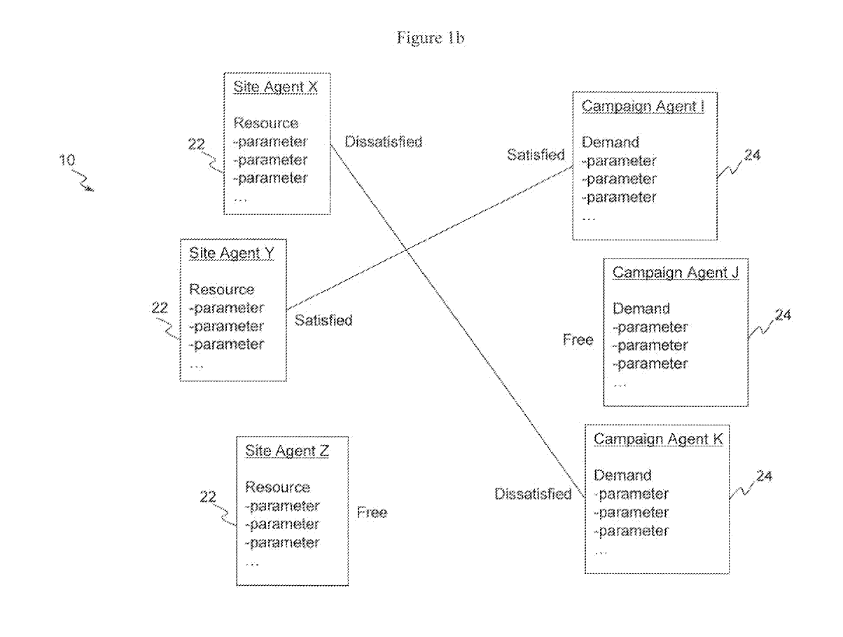

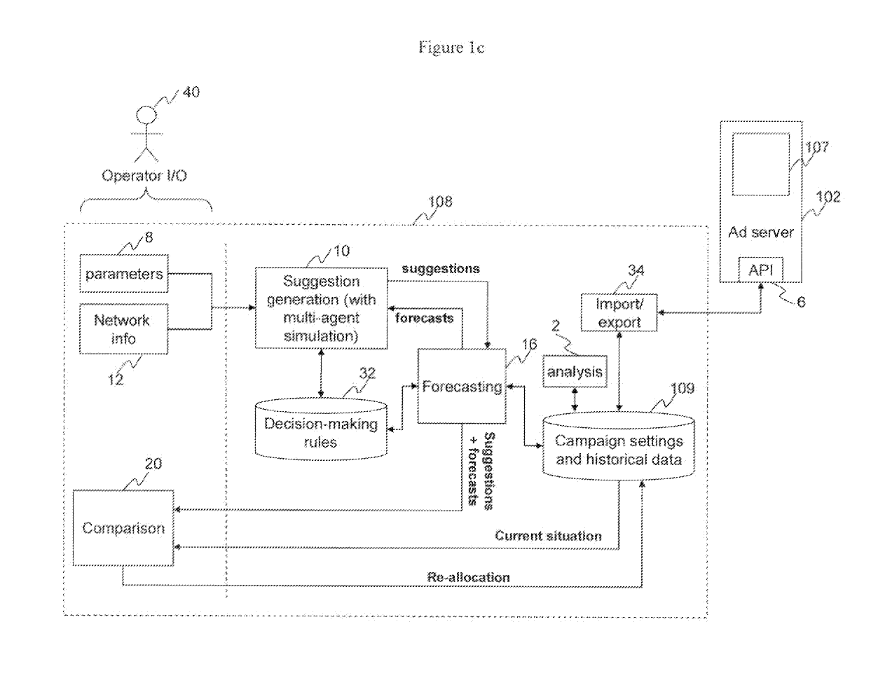

As illustrated schematically in FIG. 1a, one particular problem of resource allocation in a network occurs where content needs to be distributed amongst a plurality of end-user terminals of the network but the total viewable area for outputting that content on the end-user terminals' screens is limited. Therefore the various different portions of content can be thought of as competing with one another for the resource of viewable area, and an optimization would be desirable in order to try to maximize the overall efficiency of the use of that area.

FIG. 1a shows a network 100 comprising a plurality of servers 102 and a plurality of end-user terminals 104 interconnected via a plurality of routers represented by a communications cloud 101. Each of these servers 102 comprises a modem, a memory storing data and server software, and a processor coupled to that memory and modem, the server's processor being thus arranged to fetch and execute the server software from its respective memory and under control of that execution to make the data available to other terminals 102 and/or 104 over the network 100. Each end-user terminal 104 comprises a modem, a memory storing client software, and a processor coupled to that memory and modem, the end-user terminal's processor being thus arranged to fetch and execute the client software from its respective memory and under control of that execution to retrieve data made accessible from at least some of the servers 102.

One or more of the servers 102 each host data representing one or more respective viewable areas 106, i.e. store the data in manner making the viewable area accessible for output to the screens of the end-user terminals' 104 over the network 100. In the illustrated example, one server hosts one viewable area 106a and another server 102 hosts two separate viewable areas 106b and 106c, and one of the end-user terminals 104 is accessing one of the viewable areas 106b from the respective server 102 and outputting an instance 106b′ of that viewable area on its screen. As illustrated, each viewable area 106 may comprise one or more pages, and in the case of an area 106 comprising multiple pages then these may be accessible via links in others of those pages. Furthermore, any given page may have a viewable area larger than the actual dimensions of the screen such that the user views the rest of the page by scrolling through it (i.e. the viewable screen area is the total area that can be viewed, as opposed to the area actually viewed at any one time). Nonetheless, the total viewable area available for outputting content is a finite and limited resource.

One or more other servers 102 host the content 107 for which the viewable screen area resources 106 are to be allocated (e.g. 107a, 107b, 107c an 107d in FIG. 1a). The content 107 itself is not directly accessible from an end-user terminal 104, but instead is accessed via the viewable areas 106 and output to the user as a part thereof.

It will be appreciated of course that the example of FIG. 1a is given for illustrative purposes, and in reality there may well be more servers 102 each hosting multiple pages 106, and there may well be more portions of content 107 which could be hosted from more than one server 102.

In order to allocate the finite resource of viewable screen area 106 amongst different content 107, one of the servers 102 runs an optimizer 108 comprising executable program code. The optimizer code is stored in the server's memory, and its respective processor is arranged to fetch and execute the optimizer code, and under control of that execution to make decisions regarding the allocation of the viewable screen area resources 106 to different portions of content 107 and to indicate the allocation to the servers 102 storing the areas 106 and/or content 107 accordingly.

In preferred embodiments, the optimizer 108 dynamically proposes suggestions for re-allocating the viewable screen area resources 106 under changing network conditions, particularly as the quantity of available resources and/or quantity of content changes. The optimizer 108 may be configured to be triggered to perform a re-optimization upon detecting that the quantity of available resources and/or quantity of content has changed, or be configured to perform a re-optimization at certain intervals frequent enough to adapt to changes in the quantity of available resources and/or quantity of content changes.

The optimizer 108 is preferably implemented by means of a multi-agent simulation. The general principle of multi-agent modeling is discussed in WO03/067432. An agent is a program code module capable of communicating autonomously with other such agents. A system can be modeled by identifying key elements of the system and then providing specialized agents that have certain parameters representing those elements. Particularly, a first set of agents may be assigned representing resources and a second set of agents may be assigned representing demands for those resources. So applied to the example of FIG. 1a, some agents may be assigned within the optimizer 108 to represent respective viewable screen areas 106 and other agents may be assigned to represent respective portions of content 107. Once running, the agents then interact with one another to negotiate matches between their various parameters. Each agent is configured to exchange messages with other agents and comprises a decision-making engine for performing a decision-making process based on information from the messages of other agents and from a modeled network environment. This multi-agent simulation will be discussed in more detail below

Further, the optimizer 108 preferably comprises a data store 109, which may be provided on the same server 102, operatively coupled to the optimizer code when running. The optimizer 108 is configured so as to record in the data store 109 a history of some measure of the efficacy of the allocation of resources, and make forecasts of that measure given changes to the allocation suggested as a result of the optimizer's simulation (preferably as a result of the multi-agent simulation). These forecasts are preferably used so that a human operator of the optimizer 108 can make a decision to manually accept or decline the suggestions, but alternatively they could be used as part of a completely automated decision-making process. These forecasts will also be discussed in more detail below.

An example application of the above optimization is the placing of advertisements on websites. In this case, each viewable screen area 106 corresponds to a respective website (potentially comprising multiple web pages) having a finite, predetermined area available for advertising; and each portion of content 107 corresponds to a respective advertising campaign (potentially comprising multiple alternative images that can be used for that campaign, and/or videos, applets or text).

Many advertising campaigns are run on the Internet, which has a huge number of users, growing every day. As the Internet is nowadays one of the main resources for distribution of content to the public, it is a very attractive place for advertising. The success of advertising campaigns is typically determined by the number of user interactions (e.g. clicks) that are made. Adverts are placed on internet sites, and there are many variables surrounding placement of an advert on a particular site, including selection of a page on the site, selection of a position within a page and selection of prominence of the advert. These are just a few of the parameters that need to be taken into account. At the moment, decisions concerning such parameters are made by people, with parameters of advertising campaigns being manually adjusted.

There are many different parties which are affected by decisions concerning advertising campaigns. Advertisers, wishing to advertise on the Internet, contract with advertising agencies. These agencies in turn have contracts with the owners of sites giving advertising platforms. It is desirable that advertising agencies should place advertising campaigns on sites to satisfy interests not only of the advertising campaigns and advertisers, but also users of the internet.

There are a very large number of possible advertising sites available on the Internet, perhaps tens of billions displayed monthly. Site owners currently give the opportunity to manage the course of an advertising campaign to a specially trained operator using a program tool kit. The operator can adjust certain key parameters of the campaign, its priority, a set of sites on which it goes, a target audience etc (for the purpose of optimizing that campaign). Because of the presence of the human factor, the huge quantities of data required to be analyzed and the limited time for decision making, the optimization of advertising campaigns is extremely complex.

The field of advertising is a good example of an environment where a number of different parties have differing interests, each of which might be affected by a decision made to address the interests of one party. An advertiser, contracting with an advertising agency on distribution of its advertising in the Internet is interested in users being attracted by and offered product or service. For this purpose, an advertiser will instruct an advertising agency to implement an advertising campaign with precise restrictions and goals. The advertising campaign can be limited to a target audience, time of display, days of the week, geo location, capping or only certain sites.

An advertising campaign can have a number of goals such as: to have a certain volume of impressions (an impression is an instance of delivery of an advertisement to a user, i.e. a viewing of the advertisement); to have a certain volume of clicks; to be shown to a certain number of unique users; to achieve a certain number of purchases of the goods or services; and/or to run for a specific period of time.

The complexity of a problem to optimize an advertising campaign is caused by several factors. It is a multi-criteria optimization, needing to take these several factors into account. Besides the above-mentioned immediate goals of an advertising campaign, other influencing factors may be for example: the sum of money which is paid by the owner of the advertising company to the advertising agency, the click through rate (CTR) which is indicative of the interest of users to advertising, the number of acquisitions/order obtained by the advertising campaign, and human factors such as the behavior of Internet users, Internet sites and advertisers themselves.

The human factor is one which introduces a particular challenge in optimization of an advertising campaign. As a particular example, any changing of site content or moving a page within a site can change a contingent of users and their interests, which in turn reflects the relevance of offered advertising. Also, advertisers continually bring new advertising campaigns into the system. The goals of these campaigns can contradict each other, because the campaigns are competing for the same group of users, thus creating the risk of a certain campaign failing to deliver its objectives.

Therefore a particular problem in optimization of advertising campaigns is that the course of one advertising campaign can influence the course of another campaign. As the majority of advertising campaigns are advertised on sites together with other advertising campaigns, an advertising agency seeks to distribute site's impressions between the campaigns using campaign priorities. Thus, change of parameters of work of campaign can change not only its course, but the course of other campaigns.

The result is a highly complex network of communications between advertising campaign elements and site elements. At the moment, it is not possible to optimize all campaigns running on a network, i.e. optimization of one campaign would be local to that campaign without taking into account the consideration of its effect on other campaigns. It is presently not possible to optimize campaigns across a network globally, by human operator, because of the limited time available to trace the consequences of changes of the parameters of the campaign.

So in preferred embodiments of the present invention, the optimizer 108 uses a multi-agent simulation to model a network environment in which advertising content in the form of advertising images, videos, applets, and/or text is distributed amongst the finite viewable screen area resources of websites. By means of this simulation, the optimizer is able suggest re-allocations of the content to try to optimize the overall use of the available resources.

An example of a multi-agent simulation is illustrated schematically in FIG. 1b. The multi-agent simulation is preferably implemented by means of a plurality of site agents 22 representing the viewable screen area resources that are available for use by advertising campaigns on websites, and a plurality of campaign agents 24 representing respective content competing for said finite viewable screen area resources.

Note that by “competing” it is not necessarily meant competing in a commercial sense, but rather competing in the sense that there are not sufficient resources to satisfy the ideal requirements of all parties making use of the network. The function of the optimizer 108 is to try to maximize the overall system benefit for all parties, thus to some extent nullifying the effect of the competition for resources.

A campaign's interest is to maximize its efficiency. To this end, each campaign may have a number of specific goals which can be expressed in terms of a set of target parameters, including for example one or more of:
volume of impressions (instances of delivery of an advertisement to a user),
volume of clicks,
click-through rate (CTR) (i.e. ratio of clicks to impressions)
number of unique users viewing the advertisement,
number of purchases/leads (user actions) of the advertised goods or services,
a period of time for which the campaign is to run,
a start and/or end date for the campaign,
a particular category of site for the campaign,
an area for the advertisement,
one or more particular locations for the advertisement within a site,
whether the campaign will be exclusive to the site,
The revenue generated by the campaign, e.g. cost per 1000 impressions (CPM) or such like, cost per click (CPC) or cost per action (CPA).

Each target parameter could be expressed as a minimum value or a range of acceptable values, or perhaps simply as a preferred value. Where the target parameter is a number or volume, it could be expressed per unit time or as an absolute value for a particular amount of time.

Each site has a number of characteristic features relating to the available resource(s). These features may be expressed in terms of a set of characterizing parameters of the site, which may be matched to target parameters of campaigns, including for example one or more of:
current or forecast volume of impressions,
current or forecast volume of clicks,
current or forecast click-through-rate,
current or forecast number of purchases,
area available,
locations available,
category of the site,
whether the site can provide exclusivity.

Again, where the parameter is a number or volume, it could be expressed per unit time or as an absolute value for a particular amount of time.

Further, sites themselves may have their own interests such as: to demonstrate relevant advertising to their users which correlates to the site's content, not to demonstrate unsuitable advertising to their users, to demonstrate a variety of advertising, and/or to earn money through placing the advertisements. These may be represented by certain target parameters of the sites, such as:
category of advertising that is particularly relevant to the sites users,
category of advertising not to be shown to their users,
geographic location of the advertiser,
a measure of variety of advertising,
which may be matched to one or more characterizing parameters of the campaigns such as:
category of advertising, and/or
geographic location of the advertiser.

So in a preferred multi-agent simulation of the network environment, each site agent 22 is assigned to represents one or more available website resources, each resource being described by a set of characterizing parameters. A given resource in this sense could represent a plurality of spaces available on the website for advertising, with the parameters describing the position and size of those spaces (i.e. the idea of a resource here is not necessarily of a single advertising space). The site's characterizing parameters may also describe expected performance, and goals of the site itself such as a category of advertising.

Further, each campaign agent 24 is assigned to represent a campaign demand comprising a set of target parameters (or multiple demands if the campaign is divided into sub-campaigns). These parameters describe goals such as the click-through rate, size, location and/or category of site.

The optimization works by first matching the target parameters of campaign agents' demands to the resources of the site agents, then by campaign agents offering to swap their claimed resources with other campaign agents.

Each agent 22, 24 is an executable code module, running autonomously as part of the optimizer 108 on the respective server 102, comprising: data representing the parameters of the respective resource(s) or demand(s), code for communicating its parameters to other agents, code for signaling offers of potential matches to other agents based on those parameters, code for assessing offers of matches signaled from other agents according to its own parameters, and code for signaling offers of potential exchanges of claimed resources with other agents. The agents are said to be autonomous in the sense that the signaling is done autonomously from one another, such that each can autonomously generate offers of matches or exchanges to other agents, and each can autonomously determine whether to accept offers from other agents.

Thus agents 22, 24 and are capable of interpreting information received from other agents 22, 24 together making up the virtual world of the simulated network environment. Based on inputs, agents can make knowledge-based decisions, which are then output to other elements of the simulated network environment. In a preferred embodiment, the agent matching and exchanging works as follows.

Agents in the simulated network environment may be so-called “free” agents where there is no relation yet established with any another agents. In this case, free agents will try and establish relations with other agents by matching itself with other agents, which it identifies as potential partners using the relevant parameters. Such a matching process is called a negotiation. A relation between agents is only established if all agents to the negotiation agree and the agreement will be granted only if the proposed relation meets predefined criteria. This criteria might be a matching of certain parameters between agents.

A free agent which searches the system for a match will be in an “active” state. If no suitable match is found, the agent switches to a “passive” state and waits for an alteration in the state of the simulated network environment. Agents that have already established relations with other agents may also switch to a passive state, because they may be activated again if there is a change in the state of the simulated network environment. A change in the simulated environment can be caused by a new “event”, i.e. the arrival of a new demand or resource causing the creation of a new agent. Agents communicate with each other and with the virtual world by signaling messages.

Agents are either “free”, or in a “dissatisfied” relation or a “satisfied” relation. The meaning of these terms will be discussed shortly. When there is a change in the state of the simulated network environment, the process follows the sequence that free agents are activated first, dissatisfied agents are activated second and satisfied agents are activated last. For purposes of matching, each agent may hold a minimum and maximum value for the parameter it is trying to match. Agents seeking to match parameters can prioritize the particular parameters they require. Agents are said to be “satisfied” if for the established relation between the agents their respective maximum values for parameters are met. An agent can still establish a “dissatisfied” relation if the match is to an agent where the value of a requested parameter is greater than or equal to the minimum value. A relation will not be established with an agent if the value of the requested parameter for that agent is below the minimum value. Thus, a relation may exists between dissatisfied agents, but an agent's dissatisfaction is a strong reason for reconsidering the established relation and such agents are considered next in the sequence after all free agents have been checked for a suitable match. Finally, satisfied agents are activated last to reconsider their relations and if it is feasible the relations are re-established such that the total overall system value is increased.

In order to break an established relation between agents, compensation is offered to those agents. Compensation will only be accepted if the re-negotiated relation is to result in a relation which is more satisfied than the one which was broken. The result of this is to increase the overall efficacy or impact of the use of the finite available system resource, considered over all agents.

It should be noted that a dissatisfied relation could become less dissatisfied. It is also possible for a satisfied relation to become more satisfied by matching above the maximum value through the offer of compensation. Note also that in embodiments, then once a relation has been established, such a relation can only be aborted by mutual agreement.

By way of example, in FIG. 1b site agent 22(Z) and campaign agent 24 (J) are free, campaign agent 24(I) has established a satisfied relation with site agent 22(Y), and site agent 22(X) has established a dissatisfied relation with campaign agent 24(K). Say then that campaign agent 24(J) determines that the parameters of site agent 22(Z) match at least the minimum values of its parameters (but not its maximum values), it signals an offer of a relation to site agent 22(Z), site agent 22(Z) agrees, and they establish a dissatisfied relation. Campaign agent 24(K) may then determine that its parameters would be better matched if it swapped relations with campaign agent 24(J), and signal an offer of such a swap to campaign agent 24(J) and to site agents 22(X) and 22(Z). If they all agree, they swap by site agent 22(X) establishing a relation with campaign agent 24(J) and site agent 22(Z) establishing a relation with campaign agent 24(K). This may result in either better dissatisfied relations or satisfied relations for one or both.

One example of the algorithm for implementing dynamic resource allocation comprises the following steps:
(i) A campaign agent is allocated to a demand as it arrives to the system. The allocated campaign agent sends its parameters in a message to all free site agents requesting a resource having particular parameters.
(ii) All free site agents having resources with the requested parameters or with at least some of these parameters make an offer to the campaign agent.
(iii) The campaign agent then selects the most suitable site agent (based on their parameters) from those offers and a match is established.
(iv) If no suitable site agent is free, the campaign agent seeks to obtain a suitable resource from a previously allocated site agent, by either re-negotiating with the respective dissatisfied campaign agent involved with the established relation or alternatively offering compensation to a respective satisfied campaign agent for modifying its already established relation.
(v) The campaign agent to which the offer of compensation is made then considers the offer. The campaign agent only accepts the offer if the compensation enables it to obtain a different suitable resource with improved matching parameters, i.e. closer to (or even above) its maximum value. If the offer of compensation is accepted, this has the effect of effectively reorganizing the whole system, wherein the previously established relation between the original campaign and site agent is modified and a new relationship between the new campaign and the released site agent is established.

Process steps (i) to (iv) are repeated until all resources are linked to demands and either no established relations can be improved or until the time period available for allocation has been exhausted. That is the above process is repeated until an optimal allocation of resources has been achieved within the constrained time period.

Once the various offers of matches and exchanges between agents have been agreed or disagreed, the results are output from the simulation as suggestions for re-allocation of the resources. That is, in the preferred embodiment a human operator still has to asses whether to accept the results suggested by the multi-agent simulation.

The above multi-agent optimization is preferably performed dynamically, repeatedly outputting suggestions throughout operation of the network, adapting to changes in the network environment such as new sites or campaigns or alterations in the location or size of advertising space within sites.

In addition to the above, each campaign agent may be given a priority rating as one of its parameters. Priority may be considered in the algorithm when campaigns or sub-campaigns compete for impressions in the same site or space on a site. The priority rating could be used in a number of ways.

For example, there may be types of priority such as: ACCELERATED, HIGH, NORMAL, MODERATE and LOW. These values have a hierarchy: the ACCELERATED priority is higher than HIGH, HIGH is higher than NORMAL and so on. It means that the campaign or sub-campaign with a priority one level higher than another will be shown a certain number of times more often, e.g. five times more often. E.g. if there are two sub-campaigns or campaigns of the same type run on the same placement (space) on a site and one of them has a HIGH priority and the other has a NORMAL priority, then the first will be shown five-times more often then the second one. If another sub-campaign or campaign of the NORMAL priority is added to this placement, the proportion of the impressions frequency will be 5:1:1 (5 high priority campaigns to each of the 1 normal campaigns) in the order of addition. If another sub-campaign or campaign is added with a LOW priority, the distribution of impressions frequency will be 125:25:25:1. Thus in effect, as well as the actual area, time slots for a given area may be considered as a finite property of a screen area resource.

In another example of a priority rating scheme, the priority may determine whether a campaign of a higher rating can force a campaign of a lower rating to accept a change that is detrimental to the interests of the lower-rated campaign, i.e. worsens the match for its target parameters. So whilst in a completely “fair” simulation, agreement would be required from all affected campaign agents for a particular offered exchange, such bilateral or multilateral agreement need not be required where one of the campaign agents “offering” the change has a higher priority rating than one or more others.

Furthermore, there may also be other types of agent involved in the simulation. One example may be user agents who represent the interests of groups of end-users. A user agent's interests could be represented by parameters such as total area of advertising or category of advertising. Thus by forming relations with user agents, the resource(s) a site agent can make available may be made dependent on the demands of its user agents.

Another example may be manager agents who represent the role of advertising agencies. A manager agent's interests could be represented for example by parameters such as: total number of campaigns matched to sites, total income, average CTR, and/or absence of dissatisfied relations. In this case, the available resources are offered from site agents to a plurality of manager agents who may accept them depending on their own demands. A manager agent thus collects together a plurality of resources from site agents each depending on its own demand(s), and offers these to campaign agents, who in turn accept or decline matches depending on their own demand(s). So in embodiments, campaign agents may not directly offer matches and exchanges with site agents, but may act through manager agents.

As well as the multi-agent simulation discussed above, preferred embodiments of the present invention preferably provide the function of forecasting effects of suggested resource re-allocations based on an analysis of a past history of the network. The optimizer 108 comprises a data store 109 implemented on a computer-readable storage medium, in which is recorded historical data of activity of advertisements on websites, such as the number of clicks and/or impressions over some period in time, click-through rate (CTR), as well as for example historical data on what adverts were located where for how long. The optimizer then constructs a forecast on the likely activity over an upcoming future period of time, e.g. the next seven days, using extrapolation algorithms and historical data received from one or more of the servers 102 involved in the process, e.g. the server 102 hosting the advertisement content 107 (the “ad server”). The forecasts can then be used as characterizing parameters for the site agents in the multi-agent simulation discussed above, and/or can be output to the operator of the optimizer 108 to aid him or her in making an assessment of resource re-allocations suggested by the multi-agent simulation. Note again therefore that the output of the multi-agent simulation is preferably only in the form of suggested re-allocations, which still must be assessed and accepted or rejected by a human operator.

FIG. 1c is a schematic block diagram illustrating functional components of a system for optimizing competing advertising campaigns across a network. The optimizer 108 comprises: a first data store 109 storing historical data relating to advertising from websites and settings for the advertising campaigns, an historical data analysis stage 2, an import and export stage 34, a forecasting stage 16, a suggestion generation stage 10 using multi-agent simulation, a second data store 34 storing decision-making rules, a parameter input stage 8, a network information input stage 12 and a comparison stage 20. Each stage is preferably a function comprising a portion of executable program code stored on a memory and executed on a processor of one or more servers 102. Further, stages 8, 12 and 20 are arranged to involve at least some degree of human input from a user console, and the comparison stage 20 is arranged to provide an output to a human operator through a user console. When running, the import and export stage is operatively coupled to an application programming interface (API) 6 in the ad server 102 which stores the advertising content 107 (e.g. images, videos, applets or text). The import and export stage 34 is also coupled to the first data store 109. The first data store 109 is further coupled to the analysis stage 2, the forecasting stage 16, and the comparison stage 20. The forecasting stage 16 is further coupled to the suggestion generation stage 10 and the second data store 32. The suggestion generation stage 10 is further coupled to the parameter and network information input stage 8 and 12.

In operation, the import/export function 34 is responsible for connection with the ad server. It receives data from the ad server which are imported to the first data store 109, which is a store of historical data received from the ad server. Data is extracted from the ad server via its API 6. The first data store 109 also stores campaign settings to be output to the ad server via its API 6, including an indication of the resource allocation to be applied. The import/export function 34 acts as a buffer to exchange data between the optimizer 108 and the ad server, and allows changes to the resource allocation to be exported to the ad server for implementation once they have been accepted.

The first data store 109 thus contains data of campaigns, sites, pages and also historical data of the course of advertising campaigns, including impressions and clicks on sites. It may further store data about the distribution of users in respect of geo-targeting parameters and online targeting.

The historical data analysis function 2 analyses a course and current condition of advertising campaigns or groups of campaigns over the network 100 based on the above data, and stores results of the analysis back to the first data store 109. The historical analysis function 2 can also analyze attendance, impression utilization, audience of sites, network parameters, site content and efficiency of a course of campaign on those or other sites. The analysis is based on actual data logged by the ad server 102 storing the advertising content 107, which runs advertising campaigns across the network 100.

The parameter input function 8 provides input of the parameters of the agents for use in the multi-agent simulation in the suggestion generation stage 10, e.g. to define particular sites whose requirements must be met (for site agents), to define parameters of a chosen time intervals of a campaign course (for campaign agents), and/or to define a target audience (for user agents). Parameters may be input by a human operator of the optimizer 108, and/or their generation may involve some degree of calculation by the optimizer 108 either based on input from the operator of information automatically collected from the network.

The network information input function 12 provides input of other information about the network itself (rather than on particular sites and campaigns) which may be used in the simulation performed in the suggestion generation function 10.

The suggestion generation function 10 represents a set of rules for campaign course optimization (for example, increasing the priority of a campaign, adding new sites, removing sites with bad productivity, changing created rates within the limits of a uniform advertising campaign, changing parameters of geo-targeting, timeframe, etc.). It uses the multi-agent simulation discussed above, based on the input parameters and information. The parameters define conditions of operation of a set of rules. Each rule in the suggestion generation function 10 is directed to satisfying interests of parties in the network and considers all the elements connected with them through representative agents. Suggestions for re-allocation of network resources are then output from the suggestion generation function 10, based on matches and exchanges of resources agreed between agents in the simulation.

The suggestion generation function 10 may also comprise functionality for analyzing the scope of influence of any suggestions within the network, i.e. about how far reaching the knock-on effects may be, which may be output along with the other information about the suggestions.

Decision making rules for the simulation may be stored in the second data store 32. That store may also hold the parameters from parameter input function 8. In the second data store 32, the decision-making rules can be organized into groups of a hierarchic structure. Moreover, groups can be applied in association with rules specific for a particular ad server protocol.

The forecast function 16 is used for the estimation of the future consequences of suggestions, and also for the estimation of a situation which will arise in the future if nothing changes. Forecasting in the forecast function 16 is preferably carried out based on the multi-agent modeling and on historical information. This historical information can include, for example, the number of times sites have been visited by users and/or the number of times advertisements have been clicked. The forecasting function 16 receives suggestions output from the suggestion generation 10 as an indication of what suggested situation it needs to consider. It then generates a forecast to estimate what would happen if a certain advert was relocated to a certain site according to the suggested situation, e.g. how many extra visitors would see the advert or how many extra clicks it would get. The forecasting function 16 may also receive information on the current situation from the data store 109 in order to generate a forecast to estimate what will happen if the re-allocation is not accepted and current situation continues. Implementation of the forecasting function 16 based on outputs of the multi-agent simulation means that an agent's behavior can be reflected without distortion in the simulated model.

The forecasting function 16 preferably works based on statistics of past performance. As mentioned, the first data store 109 maintains a record of historical data of activity of advertisements on websites, received from ad servers 107. This may include for example the number of clicks and/or impressions over some period in time, click-through rate (CTR), as well as for example historical data on what adverts were located where for how long. The forecasting function extrapolates from historical data using extrapolation algorithms. For example, if the number of impressions or the CTR of an advert at a particular location within a site has been increasing approximately linearly over the last few days, the forecasting function 16 may assume that it will continue roughly linearly over the next few days. Or if the number of impressions or CTR has been constant, it may be assumed that it will remain so. Other extrapolation algorithms for fitting to more complex curves will be familiar to a person skilled in the art. The forecasting function may furthermore assume that if an old advert is replaced with a new advert, then the new advert will continue to receive the same number of impressions or CTR as the old advert would have done. Alternatively the assessment could be weighted by some measure of their popularity, e.g. each advert's CTR averaged over placements on several different sites could be used as a measure of its intrinsic popularity.

The forecasting function 16 thus generates forecasts according to both the current allocation of resources and the suggested re-allocation or resources. These forecasts are provided to the comparison function 20 to aid an operator in determining whether to accept a suggested change to the resource allocation. One or both of the forecasts may also be fed back to the suggestion generation function 10 for use as site parameters in the multi-agent simulation, so that the campaign agents can determine how well the sites' performance in terms of parameters such as click-through-rate (CTR) match their targets.

The compare function 20 can then compare forecast data for an unchanged situation against a forecast data for a situation to which a particular suggestion has been applied. Alternatively it could compare forecast data for the suggestion against data of recent performance from the first data store 109, e.g. against last week's data. The compare function 20 preferably reports this information to a human operator, and requires an affirmative input back from the operator in order for any suggested resource re-allocation to be actually applied. This allows the consequences of a particular suggestion to be analyzed thereby to provide an exact forecast of the consequences of that suggestion, with the purpose of explaining to an operator what would occur if the suggestion was applied in real life. This allows an operator to avoid mistakes, as it shows all the possible negative consequences that could result from a particular suggestion.

The compare function 20 may comprise a reporting function which forms reports about the course of advertising campaigns using historical data, and outputs them to a human operator; and an alert and notifications function which analyses the course of advertising campaigns and formulates messages which are output to the operator. Based on such reports and messages, the human operator can choose to accept or decline the suggestions.

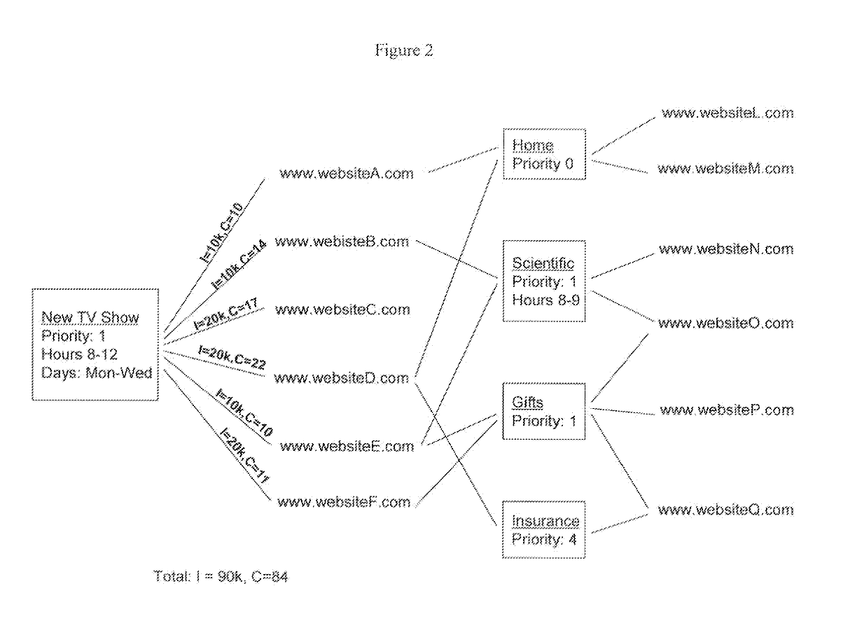

Reference will now be made to a particular example illustrated schematically in FIG. 2. This illustrates an original distribution of a set of advertising campaigns (e.g. new TV show, home, scientific, gifts, insurance) which are connected with advertising banners on websites. Each company has different priority ratings, as labeled in FIG. 2. A higher number indicates a higher priority. A campaign with a higher priority has the advantage if a certain type of client offers an opportunity to display two banners with different priorities.

The results of the new TV show advertising campaign on six internet sites during the preceding two weeks are shown on FIG. 2 (I=number of impressions, C=number of clicks). The campaign's priority is equal to one. In this example the campaign has not reached its required parameters and it is necessary to improve it. One performance related parameter is the number of clicks received by a particular advertisement. To increase the quantity of clicks which an overall campaign has, it is possible to add an extra site, resulting in more impressions for the campaign and thus additional clicks. Alternatively, it is possible to consider ways of extracting more clicks from the same volume of impressions by changing such parameters as the timing (days of week or hours) during which the campaign is displayed, dividing the campaign into two different sub-campaigns and optimizing them separately, adding a site to a general list, removing a site, or reviewing distribution for the country of the most preferable users etc. Looking at the data on FIG. 2, the most unsuccessful site can be determined by taking the ratio of the number of clicks to the number of impressions (C/I), i.e. the click-through rate (CTR). In FIG. 2, the most unsuccessful site is www.webisteF.com according to this parameter. A possibility therefore is to delete the campaign from this worst site and increase the number of impressions of the campaign on other sites.

Within the multi-agent simulation in the suggestion generation function 10, the campaign agent for the TV show knows from information signaled from site agents that its campaign has the opportunity to get more impressions on other sites. It may then signal a request to the site agents for more exact information on the number of impressions and clicks it could receive from them. If this number approximately corresponds to its need, it may delete itself from the worst site and construct a forecast as to what effect this will have, e.g. in terms of an increase or decrease in CTR. The simulation function 16 will provide it with such a forecast for some period of time, e.g. seven days, using extrapolation algorithms and feedback from the ad server. The campaign agent asses how much this forecast justifies its expectation, and if it does then it offers exchanges with one or more other campaign agents which must then asses the consequences of the decision from their own point of view. If the exchange significantly affects one of the other campaigns then such they can block or ignore such offers.

Once exchanges have been agreed between agents in the multi-agent simulation, they are output as suggestions from the suggestion generation function 10. The suggestions and corresponding forecasts are then output to the comparison function 20 where a human operator can asses the forecasts manually and decide whether to accept them.

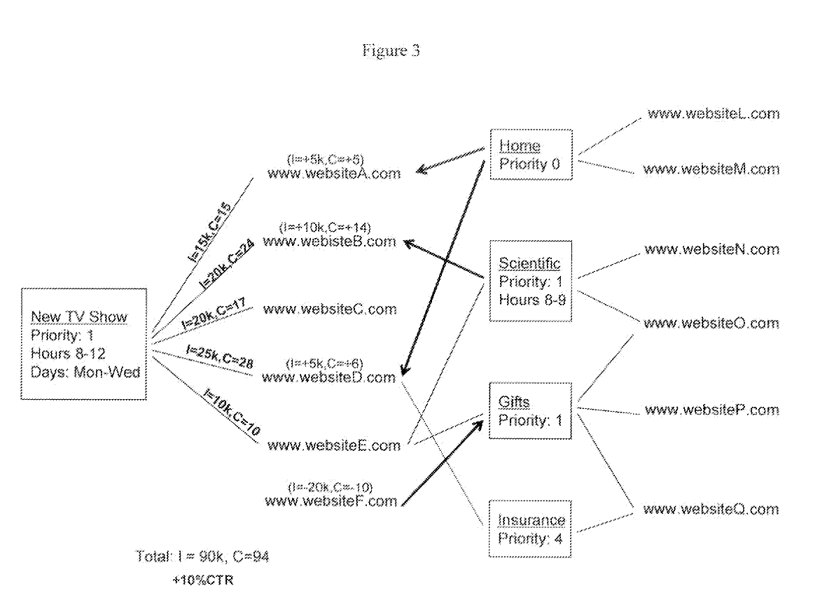

FIG. 3 illustrates the effect if the campaign deletes the www.websiteF.com site. According to the forecast, it will receive additional impressions and clicks from www.websiteA.com and www.websiteD.com, but to the detriment of advertising campaign for home related goods which has a lower priority. It cannot detract from sponsor read campaign, as that has a higher priority. On www.websiteB.com it may take some of the impressions of the scientific campaign because they have an identical priority. Furthermore, it has the effect that impressions are released from the www.websiteF.com, which are taken by the gifts campaign. The overall result is that the campaign CTR is increased by 10%. The thick arrows show the direction of the impression's redistribution after deleting the site from the new TV show campaign.

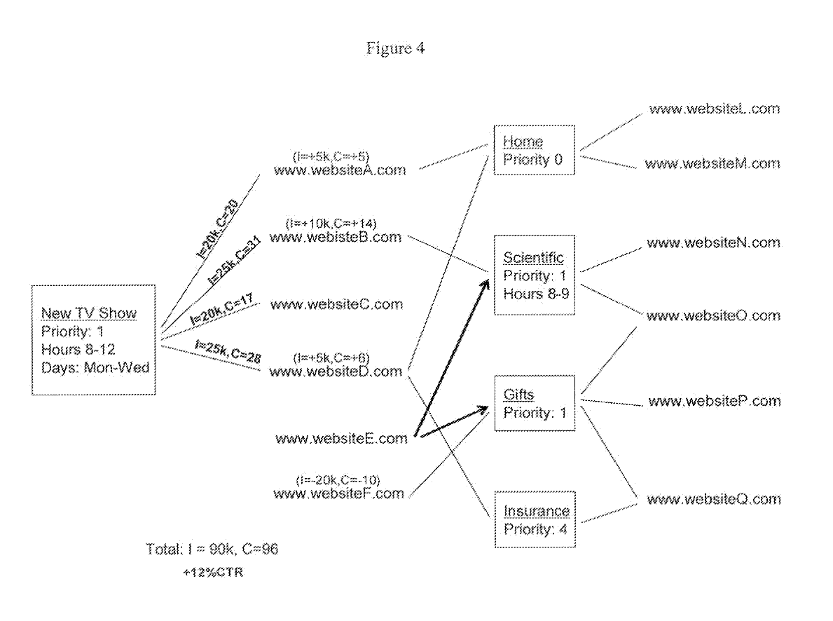

FIG. 4 illustrates a further suggestion involving removal of the site www.websiteE.com. In this case, the home campaign receives additional impressions and clicks from other sites. It is now necessary to factor in the scientific campaign, which runs only from 8 am to 9 am because it is not possible to have impressions during any other time. A scientific campaign is allocated to the site www.webisteE.com. In this case, impressions which new TV show loses from www.webisteE.com are given to the scientific campaign. Again, the thick arrows show the direction of the impression's redistribution after deleting the site from the new TV show campaign. Thus, the decision on improvement of the current campaign due to omitting www.websiteF.com leads to also omitting the www.websiteE.com site to compensate loses which would otherwise be incurred by the scientific campaign. In this case, the CTR for the TV campaign rises by 12%.

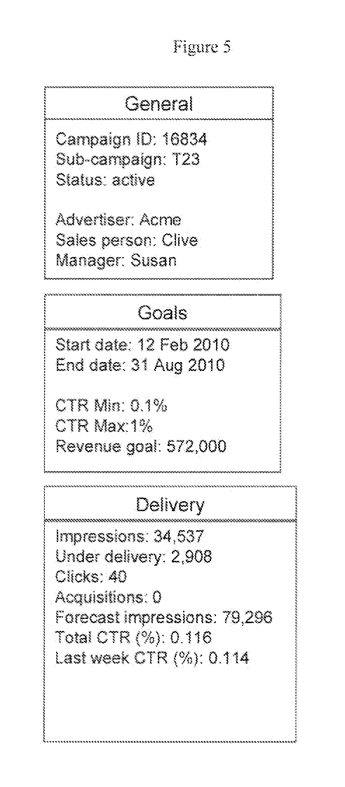

FIG. 5 shows an example of a part of the user interface for the optimizer 108 for setting up a campaign. This part of the example user interface comprises three independently summonable windows: a general window for inputting and/or displaying general descriptive information on the campaign, a goals window corresponding at least in part to the parameter input function 8 for inputting target parameters for the campaign agent, and a delivery window which outputs information from the first data store 109 and/or forecasting function 16 regarding campaign performance.

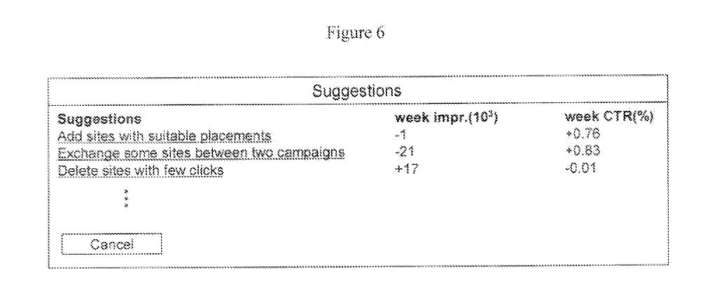

FIG. 6 shows an example of a part of the user interface for the optimizer 108 for viewing, assessing and accepting suggestions. The operator is presented with the ability to select any of the suggested options, or cancel to select none. Each suggestion is displayed in association with a corresponding forecast from the forecasting function 16.

It will be appreciated that the above embodiments are described only by way of example. For instance, referring to FIG. 1a, the viewable areas 106, the content 107, the optimizer 108 and/or data store 109 need not necessarily be implemented on separate servers as shown in FIG. 1a, nor need the optimizer 108 and data store 109 be implemented on the same server. Further, the optimizer 108 need not necessarily be implemented on one single server 102, e.g. different agents could be spread amongst different servers 102. Furthermore, the use of forecasting the effects of suggested changes is not inextricably linked to the use of multi-agent simulation in order to generate those suggestions: a multi-agent simulation could be used to generate suggested resource re-allocations without using forecasting to provide agent parameters and/or without using forecasting to aid in operator assessment of the suggestions, or conversely forecasting could be used to forecast effects of suggested changes to resource allocation generated by some other simulation means than multi-agent modeling such as a “top-down” simulation having visibility of all resources and demands. Further, the above application of the present invention to advertising is given for illustrative purposes only, and the present invention can apply to any situation in which finite viewable screen area resources are to be allocated amongst content competing for those resources. Other applications and configurations of the present invention may be apparent to the person skilled in the art given the disclosure herein. The scope of the invention is not limited by the described embodiments, but only by the following claims.

1. A network comprising:
a plurality of end-user terminals;
one or more servers operatively coupled to the end-user terminals over said network, each storing data representing one or more respective viewable screen areas and being arranged to make the viewable screen areas accessible to the end-user terminals over said network, there thus being finite viewable screen area resources accessible to the end-user terminals from those servers;
a data store; and
installed at one or more servers of said network, optimization code arranged to allocate said viewable screen area resources amongst a plurality of competing portions of content, wherein the optimization code is operatively coupled to the data store and configured to: perform a simulation of the network in order to generate proposals for changes to said resource allocation, record in the data store a history of effects of the resource allocation, and forecast an effect of proposed changes to the resource allocation based on the recorded history; such that changes to the resource allocation can be based on analysis of the forecast in relation to target parameters for the content.

2. The network of claim 1, wherein the optimization code comprises a first plurality of autonomous code modules for use in said simulation, each of the first modules representing respective content competing for said finite viewable screen area resources, and each of the first modules comprising:
data representing a set of target parameters relating to its respective content, a first code portion configured to determine potential changes to the resource allocation based on its respective target parameters and signal the potential changes to others of said modules, and a second code portion configured to determine whether such potential changes signaled from others of said first modules are acceptable according to its own respective target parameters; wherein the optimization code is configured to generate said proposed changes from said potential changes in dependence on whether thus determined acceptable.

3. The network of claim 2, wherein the optimization code comprises a second plurality of autonomous code modules for use in said simulation, each of the second modules representing a respective screen area resource, each of the second modules comprising:
data representing a set of characterizing parameters of the respective resource, and a code portion configured to determine matches between the characterizing parameters of the resource and target parameters of the content represented by the first optimization modules;
wherein the optimization code is configured to generate said proposed changes based on said matches.

4. The network of claim 1, wherein the optimization code is configured to output the forecast to an operator, allowing the operator to manually determine whether to accept the proposed changes.

5. The network of claim 3, wherein the optimization code is configured to provide said forecast to one or more of the second modules for use as one or more of the respective characterizing parameters.

6. The network of claim 1, wherein the optimization code is configured to forecast at least one of: a number of user interactions with the content, a number of user viewings of the content, and a ratio of user interactions to viewings.

7. The network of claim 2, wherein said target parameters of the first modules comprise at least one of: a number of user interactions with the content, a number of user viewings of the content, and a ratio of user interactions to viewings.

8. The network of claim 3, wherein said characterizing parameters of the second modules comprise at least one of: a number of user interactions with the content, a number of user viewings of the content, and a ratio of user interactions to viewings.

9. The network of claim 1, wherein the optimization code is configured to generate new suggestions when the quantity of viewable screen area resources available changes.

10. The network of claim 1, wherein the optimization code is configured to generate new suggestions when the quantity of content to which the viewable screen area resources are to be allocated changes.

11. The network of claim 1, wherein the optimization code is configured to perform said forecast for at least a week into the future.

12. The network of claim 1, wherein said content comprises advertising content.

13. A method of allocating viewable screen area resources amongst a plurality of competing portions of content in a network comprising a plurality of end-user terminals and one or more servers operatively coupled to the end-user terminals over said network, each of those servers storing data representing one or more respective viewable screen areas and being arranged to make the viewable screen areas accessible to the end-user terminals over said network, there thus being finite viewable screen area resources accessible to the end-user terminals from those servers, the method comprising:
performing a simulation of the network in order to generate proposals for changes to said resource allocation,
recording in a data store a history of effects of the resource allocation,
forecasting an effect of proposed changes to the resource allocation based on the recorded history, and
changing the resource allocation in dependence on analysis of the forecast in relation to target parameters for the content.

14. The method of claim 13, wherein said simulation is performed by execution of a first plurality of autonomous code modules, each of the first modules representing respective content competing for said finite viewable screen area resources, and each of the first modules comprising data representing a set of target parameters relating to its respective content;
wherein the execution of each of the first modules comprises determining potential changes to the resource allocation based on its respective target parameters, signaling the potential changes to others of said modules, and determining whether such potential changes signaled from others of said first modules are acceptable according to its own respective target parameters; and wherein said simulation comprises generating said proposed changes from said potential changes in dependence on whether thus determined acceptable.

15. The method of claim 14, wherein said simulation is performed by execution of a second plurality of autonomous code modules, each of the second modules representing a respective screen area resource, and each of the second modules comprising data representing a set of characterizing parameters of the respective resource;
wherein the execution of each of the second modules comprises determining matches between the characterizing parameters of the resource and target parameters of the content represented by the first optimization modules; and
wherein the simulation comprises generating said proposed changes based on said matches.

16. The method of claim 13, comprising outputting the forecast to an operator, such that said change in resource allocation is dependent on the operator manually determining whether to accept the proposed changes.

17. The method of claim 15, comprising providing said forecast to one or more of the second modules for use as one or more of the respective characterizing parameters.

18. The method of claim 13, wherein said forecast comprises forecasting at least one of: a number of user interactions with the content, a number of user viewings of the content, and a ratio of user interactions to viewings.

19. The method of claim 14, wherein said target parameters of the first modules comprise at least one of: a number of user interactions with the content, a number of user viewings of the content, and a ratio of user interactions to viewings.

20. The method of claim 15, wherein said characterizing parameters of the second modules comprise at least one of: a number of user interactions with the content, a number of user viewings of the content, and a ratio of user interactions to viewings.

21. The method of claim 13, wherein the simulation comprises generating new suggestions when the quantity of viewable screen area resources available changes.

22. The method of claim 13, wherein the simulation comprises generating new suggestions when the quantity of content to which the viewable screen area resources are to be allocated changes.

23. The method of claim 13, wherein the optimization code is configured to perform said forecast for at least a week into the future.

24. The method of claim 13, wherein said content comprises advertising content.

25. A computer program product for allocating viewable screen area resources amongst a plurality of competing portions of content in a network comprising a plurality of end-user terminals and one or more servers operatively coupled to the end-user terminals over said network, each of those servers storing data representing one or more respective viewable screen areas and being arranged to make the viewable screen areas accessible to the end-user terminals over said network, there thus being finite viewable screen area resources accessible to the end-user terminals from those servers, the program comprising code embodied on a computer readable medium and configured so as when executed to perform the steps of:
performing a simulation of the network in order to generate proposals for changes to said resource allocation,
recording in a data store a history of effects of the resource allocation, forecasting an effect of proposed changes to the resource allocation based on the recorded history, and enabling the resource allocation to be changed in dependence on analysis of the forecast in relation to target parameters for the content.

26. A network comprising:
a plurality of end-user terminals;
one or more servers operatively coupled to the end-user terminals over said network, each storing data representing one or more respective viewable screen areas and being arranged to make the viewable screen areas accessible to the end-user terminals over said network, there thus being finite viewable screen area resources accessible to the end-user terminals from those servers;
a data store; and
installed at one or more servers of said network, optimization code comprising a plurality of autonomous code modules, each of the modules representing respective content competing for said finite viewable screen area resources, and each of the first modules comprising: data representing a set of target parameters relating to its respective content, a first code portion configured to determine potential changes to the resource allocation based on its respective target parameters and signal the potential changes to others of said modules, and a second code portion configured to determine whether such potential changes signaled from other of said first modules are acceptable according to its own respective target parameters; such that changes to the resource allocation can be based on said potential changes if thus determined acceptable.

27. A method of allocating viewable screen area resources amongst a plurality of competing portions of content in a network comprising a plurality of end-user terminals and one or more servers operatively coupled to the end-user terminals over said network, each of those servers storing data representing one or more respective viewable screen areas and being arranged to make the viewable screen areas accessible to the end-user terminals over said network, there thus being finite viewable screen area resources accessible to the end-user terminals from those servers, the method comprising:
performing a simulation of the network in order to generate proposals for changes to said resource allocation, wherein said simulation is performed by execution of a first plurality of autonomous code modules, each of the first modules representing respective content competing for said finite viewable screen area resources, and each of the first modules comprising data representing a set of target parameters relating to its respective content, the execution of each of the first modules comprising determining potential changes to the resource allocation based on its respective target parameters and signaling the potential changes to others of said modules, and determining whether such potential changes signaled from others of said first modules are acceptable according to its own respective target parameters; and
changing the resource allocation based on said potential changes if thus determined acceptable.

28. A computer program product for allocating viewable screen area resources amongst a plurality of competing portions of content in a network comprising a plurality of end-user terminals and one or more servers operatively coupled to the end-user terminals over said network, each of those servers storing data representing one or more respective viewable screen areas and being arranged to make the viewable screen areas accessible to the end-user terminals over said network, there thus being finite viewable screen area resources accessible to the end-user terminals from those servers, the program comprising code embodied on a computer readable medium and configured so as when executed to perform the steps of:
performing a simulation of the network in order to generate proposals for changes to said resource allocation, wherein said simulation is performed by execution of a first plurality of autonomous code modules, each of the first modules representing respective content competing for said finite viewable screen area resources, and each of the first modules comprising data representing a set of target parameters relating to its respective content, the execution of each of the first modules comprising determining potential changes to the resource allocation based on its respective target parameters and signaling the potential changes to others of said modules, and determining whether such potential changes signaled from others of said first modules are acceptable according to its own respective target parameters; and
enabling the resource allocation to be changed based on said potential changes if thus determined acceptable.
